(19) United States
(12) Patent Application Publication
(10) Pub. No.: US 2016/0372078 A1
(43) Pub. Date: Dec. 22, 2016

(54) GOA CIRCUIT AND A DRIVING METHOD THEREOF, A DISPLAY PANEL AND A DISPLAY APPARATUS

(71) Applicant: BOE TECHNOLOGY GROUP CO., LTD., Beijing (CN)

(72) Inventors: Song SONG, Beijing (CN); Kayzuyoshi NAGAYAMA, Beijing (CN); Can ZHENG, Beijing (CN)

(73) Assignee: BOE Technology Group Co., Ltd., Beijing (CN)

(21) Appl. No.: 14/906,496

(22) PCT Filed: Jun. 2, 2015
(86) PCT No.: PCT/CN2015/080582

§ 371 Date: Jan. 20, 2016

(30) Foreign Application Priority Data
Jan. 27, 2015 (CN) 201510041413.9

(51) Int. Cl. G09G 5/00; G09G 5/14

(52) U.S. Cl. CPC G09G 5/003; G09G 5/14; G09G 2380/02; G09G 2300/0408; G09G 2330/021

(57) ABSTRACT

The present invention discloses a GOA circuit and a driving method thereof, a display panel and a display apparatus. The GOA circuit comprises a plurality of GOA cell groups arranged to be interconnected in series, each of the GOA cell groups comprising at least one stage of GOA cells arranged to be interconnected in series; the GOA circuit further comprises a control unit; the control unit is connected with a first stage of GOA cell in each of the GOA cell groups, for inputting a frame start signal to the first stage of GOA cell in a first GOA cell group in the display region. The GOA circuit is capable of effectively reducing the power consumption of the display product.

### RELATED APPLICATIONS

The present application is the U.S. national phase entry of PCT/CN2015/080582, with an international filing date of Jun. 2, 2015, which claims the benefit of Chinese Patent Application No. 201510041413.9, filed on Jan. 27, 2015, the entire disclosures of which are incorporated herein by reference.

### FIELD

The present disclosure relates to the display technology field and, in particular, to a GOA circuit and a driving method thereof, a display panel and a display apparatus.

### BACKGROUND

As the display techniques continue to develop, people not only demand higher quality products, but also paid higher attention to the price and utility of the display product. In order to meet the users' needs, such techniques as integration of a scan drive circuit or bilateral drive circuit on a glass substrate have emerged. Techniques of this kind can not only increase the production yield of the display product but also reduce the price of the display product significantly, thus satisfying the users' requirements on the product quality and price. Among those techniques, one of a superior importance is the realization of mass production for GOA (Gate Driver on Array). By using GOA technique to integrate a TFT (Thin Film Transistor) gate switching circuit on an array substrate of a display panel so as to form a scan drive for the display panel and therefore omit the part of a gate driving integrated circuit, the product's cost can be reduced from both aspects of the materials cost and the manufacturing processes, and the display panel can be designed to be symmetrical on both sides and with a narrow bezel. Such a gate switching circuit integrated on an array substrate using GOA technique is called a GOA circuit or a shift register circuit.

GOA circuits, as are in the prior art, cannot practice smart control as needed for real display, in particular for a foldable flexible display device. When the display panel is in a folded state, the active display region is reduced, while a prior art GOA circuit would still conduct progressive scanning of each gate line in the display panel, which will greatly increase the power consumption of the display device.

### SUMMARY

In order to reduce the power consumption of the display device, embodiments of the present invention provide a GOA circuit and a driving method thereof, a display panel and a display apparatus.

According to one aspect of the present disclosure, a GOA circuit is provided, which may comprise a plurality of GOA cell groups arranged to be interconnected in series. Each of the GOA cell groups may comprise at least one stage of GOA cell arranged to be interconnected in series. The GOA circuit may further comprise a control unit. The control unit is connected with a first stage of GOA cell in each of the GOA cell groups, for inputting a frame start signal to the first stage of GOA cell in a first GOA cell group in the display region.

According to another aspect of the present disclosure, a GOA circuit driving method is provided, for application to the above GOA circuit. The GOA circuit driving method may comprise: first, a control module inputs a frame start signal to a first stage of a GOA cell in a first GOA cell group. Next, when at least one of the GOA cell groups is in a non-display state, the control module inputs a frame start signal to the first stage of the GOA cell in the first GOA cell group in the display region, and the GOA cells located at the non-display region are not inputted with a frame start signal.

According to another aspect of the present disclosure, a display panel is provided, which may comprise the above GOA circuit.

According to a further aspect of the present disclosure, a display apparatus is provided, which may comprise the above display panel.

Among the GOA circuit and the driving method thereof, display panel and display apparatus as provided by the present disclosure, the GOA circuit comprises a plurality of GOA cell groups arranged to be interconnected in series, each GOA cell group comprises at least one stage of GOA cell arranged to be interconnected in series, and a control unit is connected to a first stage of GOA cell in each GOA cell group. With the GOA circuit in such a structure, when partial region of a display panel is not needed for display, the control unit, by inputting an STV signal to a first stage of GOA cell in a first GOA cell group corresponding to the region requiring display, can enable the display panel to start scanning from this stage of GOA cell, and particularly for a flexible foldable display panel, such a GOA circuit can keep the non-display GOA cell groups of the folded portion in an OFF state, thereby effectively reducing the power consumption of the display product.

### BRIEF DESCRIPTION OF DRAWINGS

In order to illustrate the technical solution in the present disclosure more clearly, the accompanying drawings will be briefly introduced as follows. The drawings in the following description are only some embodiments of the present disclosure. For a person of ordinarily skilled in the art, other drawings may be derived from these drawing without making any inventive effort and therefore fall within the scope of the present disclosure.

FIG. 1 is a schematic diagram of a structure of a GOA circuit provided by an embodiment of the present disclosure;

FIG. 2 is a schematic diagram of a gate line tail end structure in a GOA circuit provided by an embodiment of the present disclosure;

FIG. 3 is a schematic diagram of the circuit connection of a GOA circuit provided by an embodiment of the present disclosure;

FIG. 4 is a schematic diagram of the circuit connection of a gate line tail end structure in a GOA circuit arranged corresponding to FIG. 3;

FIG. 5 is a schematic time sequence diagram of a control signal for a GOA circuit provided by an embodiment of the present disclosure;

FIG. 6 is another schematic time sequence diagram of a control signal for a GOA circuit provided by an embodiment of the present disclosure;

FIG. 7 is yet another schematic time sequence diagram of a control signal for a GOA circuit provided by an embodiment of the present disclosure;

FIG. 8 is a schematic diagram of the circuit connection of another GOA circuit provided by an embodiment of the present disclosure;

FIG. 9 is a schematic diagram of the circuit connection of a gate line tail end structure in a GOA circuit arranged corresponding to FIG. 8;

FIG. 10 is a schematic diagram of the circuit connection of another GOA circuit provided by an embodiment of the present disclosure;

FIG. 11 is a schematic diagram of the circuit connection of another GOA circuit provided by an embodiment of the present disclosure;

FIG. 12 is a reference diagram of the input and output signals of the encoder as shown in FIG. 11; and

FIG. 13 is a schematic flow chart of a driving method for a GOA circuit provided by an embodiment of the present disclosure.

### DETAILED DESCRIPTION

In order to make the object of the present disclosure, the technical solution, and the advantages of the present disclosure clearer, the following the implementation of the present disclosure will be further described in detail in conjunction with the accompanying drawings.

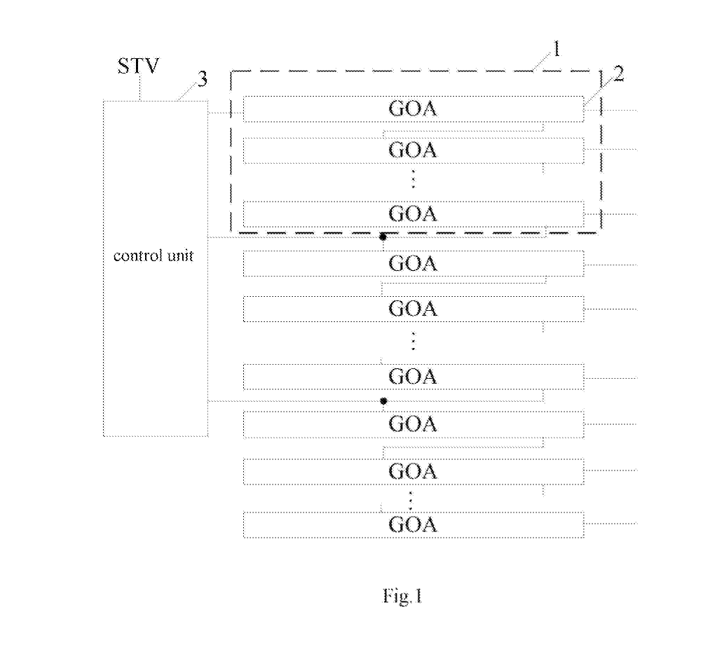

As shown in FIG. 1, a GOA circuit comprises a plurality of GOA cell groups 1 arranged to be interconnected in series, and each GOA cell group 1 comprises at least one stage of GOA cell 2 arranged to be interconnected in series, wherein the GOA circuit further comprises a control unit 3.

The control unit 3 is connected with a first stage of GOA cell in each GOA cell group 1 for inputting a frame start signal STV to the first stage of GOA cells in a first GOA cell group in the display region.

In the GOA circuit, the GOA circuit comprises a plurality of GOA cell groups arranged to be interconnected in series. Each GOA cell group comprises at least one stage of GOA cell arranged to be interconnected in series, and a control unit is connected with a first stage of GOA cell in each GOA cell group. With the GOA circuit in such a structure, when partial region of a display panel is not needed for display, the control unit, by inputting an STV signal to a first stage of GOA cell in a first GOA cell group corresponding to the region requiring display, can enable the display panel to start scanning from this stage of GOA cell, and particularly for a flexible foldable display panel, such a GOA circuit can keep the non-display GOA cell groups of the folded portion in an OFF state, thereby effectively reducing the power consumption of the display product.

It needs to be noted that since the GOA circuit is divided into a plurality of GOA cell groups interconnected in series, each GOA cell group can be called one stage of GOA cell groups in the GOA circuit, and a first GOA cell group located in the plurality of GOA cell groups interconnected in series is namely a first stage of GOA cell groups. Similarly, a first GOA cell in the GOA cells interconnected in series in each GOA cell group can be called a first stage of GOA cell.

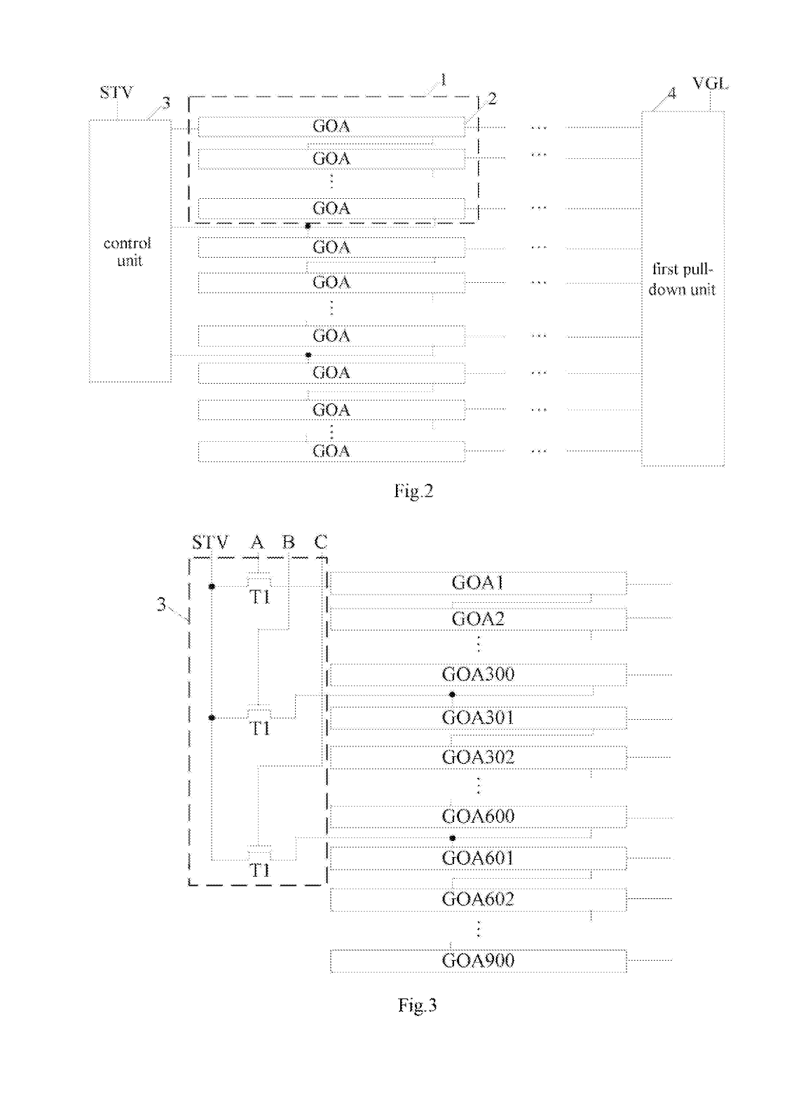

Further, as shown in FIG. 2, the GOA circuit may further comprise a first pull-down unit 4.

The first pull-down unit 4 is connected with a tail end of a plurality of gate lines respectively, for pulling down the electric potential of gate lines located at the non-display region to a low level under the control of a pull-down control signal.

Specifically, a head end of each gate line is generally connected with a GOA cell which is used for inputting a row scanning signal to the gate lines. The row scanning signal inputted to each row of gate lines is then used as a start signal for the next row of GOAs. In order to prevent the electric potential of gate lines in the non-display region from getting too high, which would generate impact on the other rows, the first pull-down unit 4 can be arranged at a tail end of the gate lines to thereby further pull down the voltage of the gate lines in that region, prevent interferences between individual GOA cells and further reduce the power consumption.

Particularly, in a foldable flexible substrate, generally partial display region is in a display state all the time, and a tail end of each gate line located in this region may not need to be connected with the first pull-down unit.

As shown in FIG. 3, the control unit 3 comprises at least one first transistor T1. A gate of the first transistor T1 is connected with a control signal, and a first terminal is inputted with a frame start signal STV, while a second terminal is connected to a first stage of GOA cell in each GOA cell group.

In FIG. 3, a foldable flexible substrate is taken as an example for illustration. The flexible substrate is capable of being folded into three equal sections, respectively the 1-300 rows of GOA cells, 301-600 rows of GOA cells, and 601-900 rows of GOA cells as three GOA cell groups. Referring to the GOA circuit shown in FIG. 3, the gates of three first transistors T1 are connected with control signals A, B, C respectively, and each of the first terminals is inputted with a frame start signal STV. The second terminals are connected to the 1st, the 301st, and the 601st row of GOA cells respectively. It should be understood that the above illustration is only exemplary, whereas in real applications, a display panel may comprise more or fewer GOA cell groups than those shown in FIG. 3, and the number of GOA cells in each GOA cell group may differ.

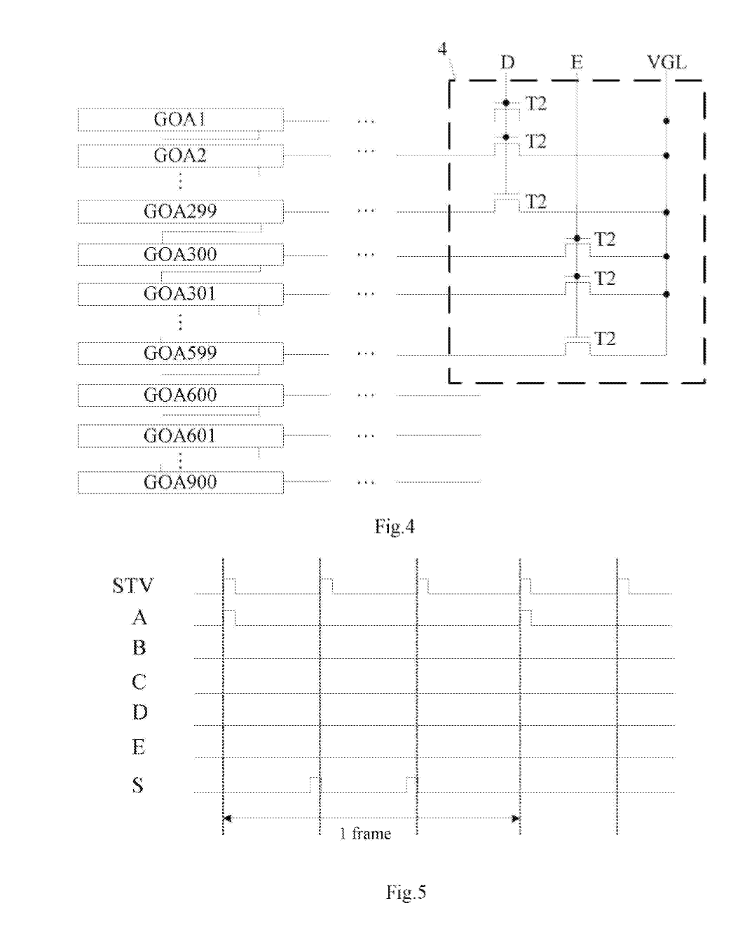

As shown in FIG. 4, the first pull-down unit 4 comprises at least one second transistor T2.

Therein, a gate of the second transistor T2 is connected with a pull-down control signal, and a first terminal is connected with a tail end of each gate line, while a second terminal is connected with a low-level VGL.

The second transistors T2 corresponding to GOA cells in each GOA cell group are connected with a same pull-down control signal as the second transistor T2 corresponding to the last stage of GOA cell in a previous GOA cell group adjacent to said GOA cell group.

Corresponding to the control unit 3 structure as shown in FIG. 3, in conjunction with FIG. 4, a foldable flexible substrate may be utilized for purposes of illustration. The gates of the second transistors T2 corresponding to the 1st to 299th rows of gate lines are all connected with the pull-down control signal D, and the gates of the second transistors T2 corresponding to the 300th to 599th rows of gate lines are all connected with the pull-down control signal E. Since the 600th to 900th rows are in a display state all the time, they may not need to be connected to a second transistor T2. By such a connection in cooperation with the control unit shown in FIG. 3, since in the GOA circuit shown in FIG. 3, while each first transistor T1 inputs a frame start signal to a first stage of a GOA cell in a GOA cell group, the frame start signal would also serve as an output signal from a previous stage of GOA cell. A GOA cell (except for the last stage of GOA cell) in each GOA cell group has the same ON/OFF state as the last stage of GOA cell in a previous GOA cell group adjacent to said GOA cell group. Accordingly, the first pull-down unit shown in FIG. 4 can be used to carry out the pull-down of the gate line potential.

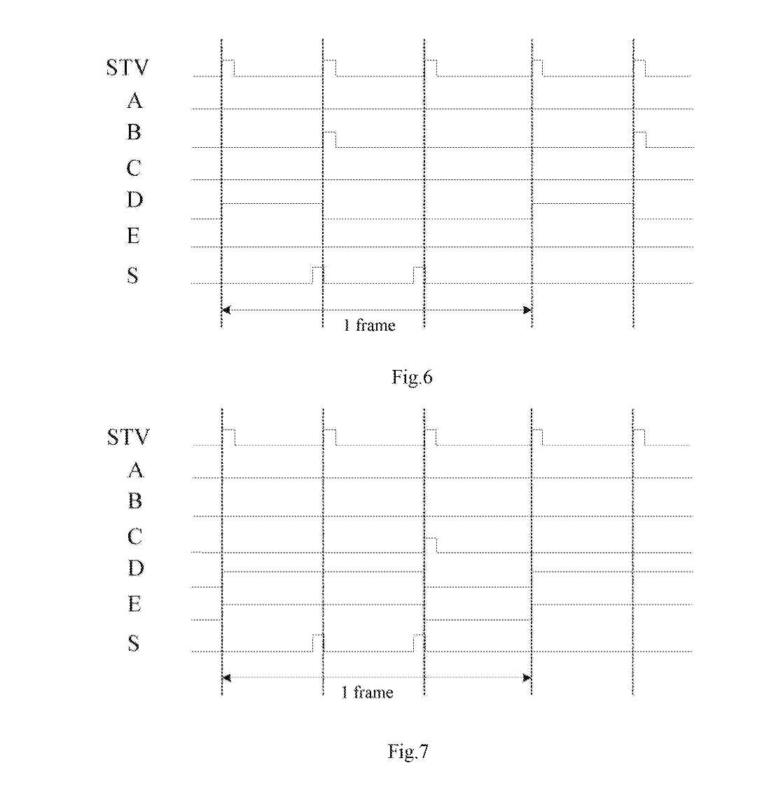

Specifically, a time sequence of the control signal for a GOA circuit shown in FIG. 3 and FIG. 4 can be as shown in FIG. 5 to FIG. 7. When the flexible display panel is not folded, a time sequence of the control signal can be as shown in FIG. 5, wherein control signal A controls the transistor T1 to turn on the 1st row of GOA cells periodically. When the 1st to 300th rows of the flexible display panel are folded, the region of the 1st to 300th rows are in a non-display state, where a time sequence of the control signal may be as shown in FIG. 6, such that control signal B controls the transistor T1 to turn on the 301st row of GOA cells periodically, and within a corresponding scanning time for the 1st to 300th rows, pull-down control signal D controls the transistors T2 to pull down the electric potential of the 1st to 299th rows of gate lines. When the 1st to 600th rows of the flexible display panel are all folded, the region of the 1st to 600th rows are in a non-display state, where a time sequence of the control signal is as shown in FIG. 7, such that control signal C controls the transistor T1 to turn on the 601st row of GOA cells periodically, and within a corresponding scanning time for the 1st to 600th rows, pull-down control signals D, E control the transistors T2 to pull down the electric potential of the 1st to 299th rows of gate lines and of the 300th to 599th rows of gate lines, respectively.

Particularly, when an active display region of the display panel is reduced to ⅓, correspondingly the screen refreshing frequency can be increased, i.e. three refreshes should be done within the duration of one frame previously, such that the refreshing frequency will be increased to three times higher. Of course, this is the case for the example of division into three equal sections. It should be understood that for other display panels of n equal sections, when an active display region of the display panel is reduced to 1/n, correspondingly the screen refreshing frequency can also be increased, to an n times higher refreshing frequency.

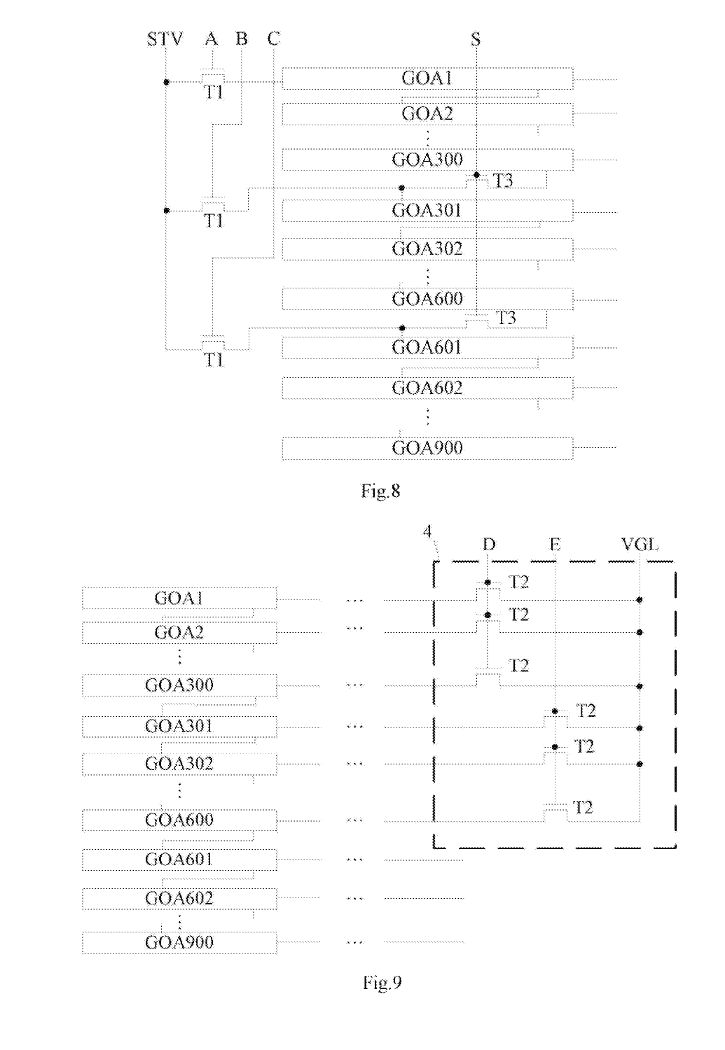

As shown in FIG. 8, the GOA circuit further comprises at least one third transistor T3.

Therein, a gate of the third transistor T3 is connected with an isolating control signal S, and a first terminal is connected to an input end of a first stage of GOA cell in a GOA cell group, while a second terminal is connected to an output end of the last stage of GOA cell in a previous GOA cell group adjacent to said GOA cell group.

As shown in FIG. 8, a foldable flexible substrate can also be taken as an example for illustration. A third transistor T3 can be arranged between the 300th and the 301st rows of GOA cells and the 600th and the 601st rows of GOA cells, respectively. In this way, when the first transistor T1 inputs a frame start signal to a first stage of GOA cell in a GOA cell group, the third transistor T3 is capable of disconnecting the first stage of GOA cell from the last stage of GOA cell in a previous GOA cell group, thereby avoiding the frame start signal to be as an output of the last stage of GOA cell in a previous GOA cell group.

Correspondingly, as shown in FIG. 9, the first pull-down unit further comprises at least one second transistor T2.

A gate of the second transistor T2 is connected with a pull-down control signal, and a first terminal is connected with a tail end of each gate line, while a second terminal is connected to a low-level VGL.

The second transistors T2 corresponding to GOA cells in each GOA cell group are connected with a same pull-down control signal.

Corresponding to the GOA circuit shown in FIG. 8, since an effective isolation is applied between the 300th and the 301st rows of GOA cells and between the 600th and the 601st rows of GOA cells, the transistors T2 connected to gate lines corresponding to GOA cells in a GOA cell group can be connected with a same pull-down control signal, and besides, since the 601st to 900th rows are in a display state all the time, they may not need to be connected to second transistors T2.

Specifically, a time sequence of the control signal for the GOA circuit shown in FIG. 8 and FIG. 9 can also refer to FIG. 5-FIG. 7. Therein, an isolating control signal S controls over a disconnection between the 300th and the 301st rows of GOA cells and between the 600th and the 601st rows of GOA cells periodically. Other control signals are as described in the above, which will not be repeated here.

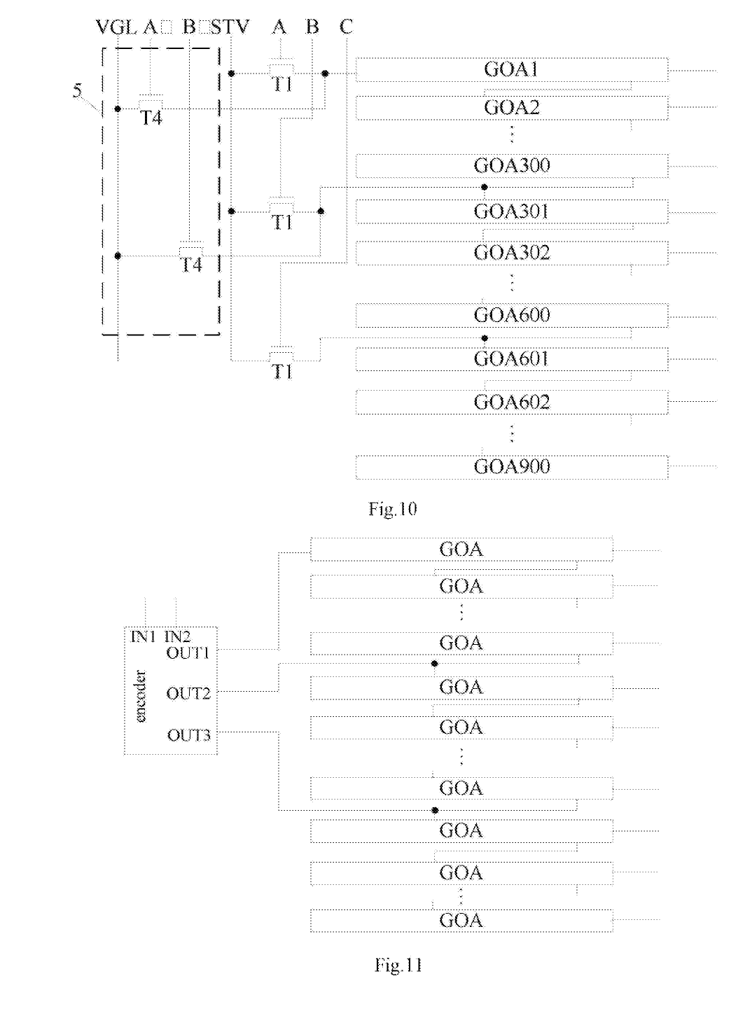

In addition, as shown in FIG. 10, the GOA circuit further comprises a second pull-down unit 5.

The second pull-down unit 5 is connected with an input end of a first stage of a GOA cell in each GOA cell group, for pulling down the input end of the first stage of GOA cell in a GOA cell group located at the non-display region to a low level under the control of an OFF signal.

Specifically, as shown in FIG. 10, the second pull-down unit 5 comprises at least a fourth transistor T4.

Therein, a gate of the fourth transistor T4 is connected with an OFF signal, and a first terminal is connected with a low-level VGL, while a second terminal is connected to an input end of a first stage of GOA cell in a GOA cell group.

A foldable flexible substrate can also be taken as an example for illustration. A fourth transistor T4 is connected with an input end of a first row of GOA cells, for pulling down the voltage of the input end of the first row of GOA cells to VGL under the control of the OFF signal A′. Another fourth transistor T4 is connected to an input end of the 301st row of GOA cells, for pulling down the voltage of the input end of the first row of GOA cells to VGL under the control of the OFF signal B′. With such a structure of the second pull-down unit 5 as designed, it can be further ensured that the GOA cells are efficiently turned off and the power consumption is reduced effectively.

It needs to be noted that the transistor used in the present disclosure can be a thin film transistor or a field effect transistor or other devices with the same characteristics, and since the source and the drain of the transistor used herein are symmetrical, the source and the drain are of no difference. In the present disclosure, in order to distinguish between the two terminals other than the gate of the transistor, one of the two terminals is called a first terminal, while the other terminal is called a second terminal. Besides, by characteristics, the transistor can be divided into an N type and a P type, and an N type transistor will be taken as an example for illustration throughout the following embodiments. When an N type transistor is adopted, the first terminal can be a source of the N type transistor, while the second terminal can be a drain of the N type transistor. It can be conceived that a person skilled in the art can easily think of the implementation using a P type transistor without making any inventive effort, and this is also within the scope of the present disclosure.

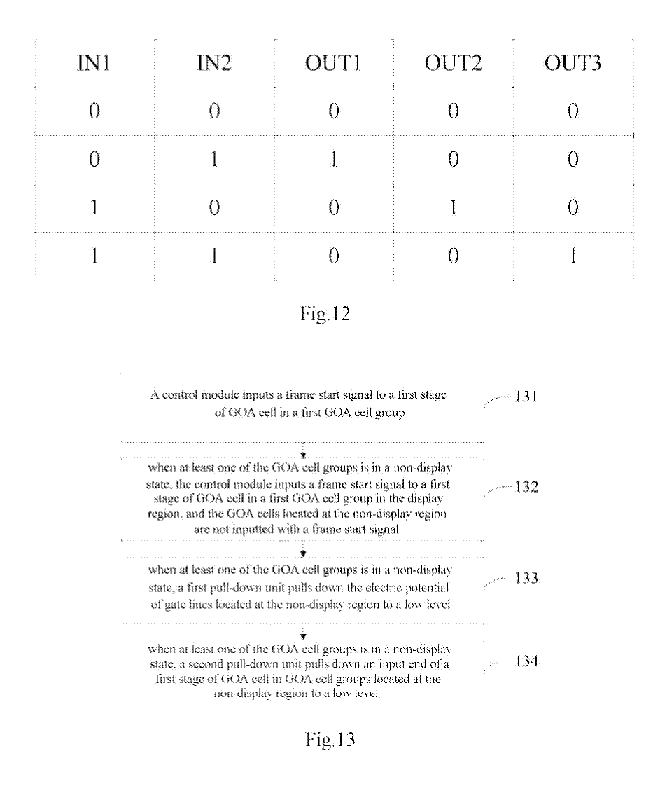

As shown in FIG. 11, the control unit 3 further comprises an encoder. Taking a foldable flexible substrate for example, an encoder provided by the present disclosure may have two input ends and three output ends, and each output end is respectively connected to a first stage of a GOA cell in a GOA cell group. Therein, the relations between the input and the output of the encoder can be as shown in FIG. 12, and a level of the output signal can refer to the preceding embodiments.

FIG. 13 illustrates a flow chart of a GOA circuit driving method applicable to the aforesaid GOA circuit. In step 131, a control module inputs a frame start signal to a first stage of GOA cell in a first GOA cell group. In step 132, when at least one of the GOA cell groups is in a non-display state, the control module inputs a frame start signal to a first stage of GOA cell in a first GOA cell group in the display region, and the GOA cells located at the non-display region are not inputted with a frame start signal.

In the GOA circuit driving method shown in FIG. 13, the GOA circuit comprises a plurality of GOA cell groups arranged to be interconnected in series, each GOA cell group comprises at least one stage of GOA cell arranged to be interconnected in series, and a control unit is connected with a first stage of GOA cell in each GOA cell group. With the GOA circuit in such a structure, when partial region of a display panel is not needed for display, the control unit, by inputting an STV signal to a first stage of GOA cell in a first GOA cell group corresponding to the region requiring display, can enable the display panel to start scanning from this stage of the GOA cell, and particularly for a flexible foldable display panel, such a GOA circuit can keep the non-display GOA cell groups of the folded portion in an OFF state, thereby effectively reducing the power consumption of the display product.

Further, as shown in FIG. 13, the method further comprises: in step 133, when at least one of the GOA cell groups is in a non-display state, a first pull-down unit pulls down the electric potential of gate lines located at the non-display region to a low level.

In step 134, when at least one of the GOA cell groups is in a non-display state, a second pull-down unit pulls down an input end of a first stage of GOA cell in GOA cell groups located at the non-display region to a low level.

The specific steps of the GOA circuit driving method and the time sequence of the related signals are already described in detail in the preceding embodiments, which will not be repeated here.

The present disclosure also provides a display panel comprising the aforesaid GOA circuit.

Therein, the structure of the GOA circuit is already described in the preceding embodiments, which will not be repeated here.

The display panel provided by the present disclosure comprises a GOA circuit which comprises a plurality of GOA cell groups arranged to be interconnected in series, each GOA cell group comprises at least one stage of GOA cell arranged to be interconnected in series, and a control unit is connected with a first stage of GOA cell in each GOA cell group. With the GOA circuit in such a structure, when partial region of a display panel is not needed for display, the control unit, by inputting an STV signal to a first stage of GOA cell in a first GOA cell group corresponding to the region requiring display, can enable the display panel to start scanning from this stage of GOA cell, and particularly for a flexible foldable display panel, such a GOA circuit can keep the non-display GOA cell groups of the folded portion in an OFF state, thereby effectively reducing the power consumption of the display product.

The present disclosure also provides a display apparatus comprising the aforesaid display panel.

In some embodiments, the display apparatus may be: a liquid crystal panel, an electronic paper, an OLED panel, a mobile phone, a tablet computer, a TV set, a display, a notebook computer, a digital photo frame, a navigator, or any other product or part with a displaying function.

The display apparatus provided by the present disclosure comprises a display panel which comprises a GOA circuit. The GOA circuit comprises a plurality of GOA cell groups arranged to be interconnected in series, each GOA cell group comprises at least one stage of GOA cells arranged to be interconnected in series, and a control unit is connected with a first stage of GOA cell in each GOA cell group. With the GOA circuit in such a structure, when partial region of a display panel is not needed for display, the control unit, by inputting an STV signal to a first stage of GOA cell in a first GOA cell group corresponding to the region requiring display, can enable the display panel to start scanning from this stage of GOA cell, and particularly for a flexible foldable display panel, such a GOA circuit can keep the non-display GOA cell groups of the folded portion in an OFF state, thereby effectively reducing the power consumption of the display product.

An person in the art can understand that all or a part of the steps to carry out the above embodiments may be accomplished by hardware or by a program instructing related hardware to perform the steps described herein, and the program may be stored in a computer readable storage medium. The above-mentioned storage medium may be a read-only memory, a magnetic disk, an optic disc, etc..

Described above are only embodiments of the present disclosure, which are not used to limit the present disclosure. Any modification, equivalent substitution, improvement, etc. within the spirit and principle of the present disclosure should be included in the scope of the present disclosure.

1-14. (canceled)

15. A GOA circuit comprising:
a plurality of GOA cell groups arranged to be interconnected in series, each of the GOA cell groups comprising at least one stage of a GOA cell arranged to be interconnected in series, wherein the GOA circuit further comprises a control unit;
wherein the control unit is connected with a first stage of GOA cell in each of the GOA cell groups, for inputting a frame start signal to the first stage of GOA cell in a first GOA cell group in the display region.

16. The GOA circuit according to claim 15, wherein the GOA circuit further comprises a first pull-down unit, wherein the first pull-down unit is connected with tail ends of a plurality of gate lines respectively, for pulling down electric potential of the gate lines located at the non-display region to a low level under the control of a pull-down control signal.

17. The GOA circuit according to claim 16, wherein the control unit comprises at least one first transistor, wherein a gate of the first transistor is connected with a control signal, and a first terminal is inputted with a frame start signal, and wherein a second terminal is connected to a first stage of a GOA cell in each of the GOA cell groups.

18. The GOA circuit according to claim 16, wherein the first pull-down unit comprises at least one second transistor, wherein a gate of the second transistor is connected with the pull-down control signal;
wherein a first terminal is connected with a tail end of each gate line, while a second terminal is connected to a low level; and
wherein the second transistors corresponding to GOA cells in each of the GOA cell groups are connected with the same pull-down control signal as the second transistor corresponding to the last stage of GOA cell in a previous one GOA cell group adjacent to said GOA cell group.

19. The GOA circuit according to claim 17, wherein the GOA circuit further comprises at least one third transistor;
Wherein a gate of the third transistor is connected with an isolating control signal;
wherein a first terminal is connected to an input end of a first stage of GOA cell in one of the GOA cell groups;
and wherein a second terminal is connected to an output end of the last stage of GOA cell in a previous one GOA cell group adjacent to said GOA cell group.

20. The GOA circuit according to claim 19, wherein the first pull-down unit comprises at least one second transistor;
wherein a gate of the second transistor is connected with a pull-down control signal;
wherein a first terminal is connected with a tail end of each gate line, while a second terminal is connected to a low level; and
wherein the second transistors corresponding to GOA cells in each of the GOA cell groups is connected with the same pull-down control signal.

21. The GOA circuit according to claim 15, further comprising a second pull-down unit;
wherein the second pull-down unit is connected with an input end of a first stage of GOA cell in each of the GOA cell groups, for pulling down the input end of the first stage of GOA cell in the GOA cell group located at the non-display region to a low level under the control of an OFF signal.

22. The GOA circuit according to claim 16, further comprising a second pull-down unit;
wherein the second pull-down unit is connected with an input end of a first stage of GOA cell in each of the GOA cell groups, for pulling down the input end of the first stage of GOA cell in the GOA cell group located at the non-display region to a low level under the control of an OFF signal.

23. The GOA circuit according to claim 21, wherein the second pull-down unit comprises at least one fourth transistor;
wherein a gate of the fourth transistor is connected with an OFF signal, a first terminal is connected with a low level, and a second terminal is connected to an input end of a first stage of GOA cell in GOA cell groups.

24. The GOA circuit according to claim 22, wherein the second pull-down unit comprises at least one fourth transistor;
wherein a gate of the fourth transistor is connected with an OFF signal, a first terminal is connected with a low level, and a second terminal is connected to an input end of a first stage of GOA cell in GOA cell groups.

25. The GOA circuit according to claim 15, wherein the control unit comprises an encoder.

26. The GOA circuit according to claim 16, wherein the control unit comprises an encoder.

27. A GOA circuit driving method for application to the GOA circuit according to claim 15, the method comprising:
inputting, via a control module, a frame start signal to a first stage of a GOA cell in a first GOA cell group;
when at least one of the GOA cell groups is in a non-display state, inputting, via the control module, a frame start signal to a first stage of GOA cell in a first GOA cell group in the display region, and the GOA cells located at the non-display region are not inputted with a frame start signal.

28. The GOA circuit driving method according to claim 27, wherein the method further comprises:
when at least one of the GOA cell groups is in a non-display state, a first pull-down unit pulls down the electric potential of gate lines located at the non-display region to a low level.

29. The GOA circuit driving method according to claim 27, wherein the method further comprises:
when at least one of the GOA cell groups is in a non-display state, a second pull-down unit pulls down an input end of a first stage of GOA cell in GOA cell groups located at the non-display region to a low level.

30. A display panel comprising the GOA circuit according to claim 15.

31. A display panel comprising the GOA circuit according to claim 16.

32. A display panel comprising the GOA circuit according to claim 17.

33. A display panel comprising the GOA circuit according to claim 18.

34. A display apparatus comprising the display panel according to claim 30.
